(19) United States
(12) Patent Application Publication
(10) Pub. No.: US 2026/0089547 A1
(43) Pub. Date: Mar. 26, 2026

(54) TECHNIQUES FOR USER EQUIPMENT COOPERATION IN WIRELESS COMMUNICATIONS

(71) Applicant: QUALCOMM Incorporated, San Diego, CA (US)

(72) Inventors: Mostafa KHOSHNEVISAN, San Diego, CA (US); Xiaoxia ZHANG, San Diego, CA (US); Aleksandar DAMNJANOVIC, Del Mar, CA (US); Navid ABEDINI, Basking Ridge, NJ (US)

(21) Appl. No.: 18/893,691

(22) Filed: Sep. 23, 2024

(51) Int. Cl. H04W 28/02; H04L 1/00; H04L 5/00

(52) U.S. Cl. CPC H04W 28/0268; H04L 1/0003; H04L 5/0053; H04W 28/0278

(57) ABSTRACT

Methods, systems, and devices for wireless communications are described in which a first user equipment (UE) may communicate with a network entity with the assistance of one or more second UEs. The first UE may provide information to a serving network entity about a link quality of UE-to-UE links that are used the communications via multiple UEs. The network entity may use this information to adjust communications parameters with the first UE for a network-to-UE link that uses multiple UEs. The adjusted parameters may include an adjusted modulation and coding scheme, adjusted feedback timing, or combinations thereof. For uplink communications, the information about the link quality of the UE-to-UE link may include separate buffer status reports for the first UE and for the one or more second UEs.

### FIELD OF TECHNOLOGY

The following relates to wireless communications, including techniques for user equipment cooperation in wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a first user equipment (UE) is described. The method may include determining a link property of a first link between the first UE and a second UE, where the second UE assists with communications between the first UE and a network entity, transmitting an indication of the link property of the first link to the network entity via a second link between the first UE and the network entity, and communicating with the network entity, via the second link using one or more second link parameters that are based on the link property of the first link.

A first UE for wireless communications is described. The first UE may include one or more memories storing processor executable code, and one or more processors coupled with the one or more memories. The one or more processors may individually or collectively be operable to execute the code to cause the first UE to determine a link property of a first link between the first UE and a second UE, where the second UE assists with communications between the first UE and a network entity, transmit an indication of the link property of the first link to the network entity via a second link between the first UE and the network entity, and communicate with the network entity, via the second link using one or more second link parameters that are based on the link property of the first link.

Another first UE for wireless communications is described. The first UE may include means for determining a link property of a first link between the first UE and a second UE, where the second UE assists with communications between the first UE and a network entity, means for transmitting an indication of the link property of the first link to the network entity via a second link between the first UE and the network entity, and means for communicating with the network entity, via the second link using one or more second link parameters that are based on the link property of the first link.

A non-transitory computer-readable medium storing code for wireless communications is described. The code may include instructions executable by one or more processors to determine a link property of a first link between the first UE and a second UE, where the second UE assists with communications between the first UE and a network entity, transmit an indication of the link property of the first link to the network entity via a second link between the first UE and the network entity, and communicate with the network entity, via the second link using one or more second link parameters that are based on the link property of the first link.

In some examples of the method, first UEs, and non-transitory computer-readable medium described herein, transmitting the indication of the link property of the first link may include operations, features, means, or instructions for transmitting a first link failure indication to the network entity that indicates whether a link failure of the first link is associated with one or more downlink transport block communications from the network entity. In some examples of the method, first UEs, and non-transitory computer-readable medium described herein, the first link failure indication may be provided in a multi-state acknowledgment/negative-acknowledgment (ACK/NACK) feedback indication associated with each of the one or more downlink transport block communications that indicates whether the first link experienced a failure associated with a corresponding downlink transport block communication.

In some examples of the method, first UEs, and non-transitory computer-readable medium described herein, transmitting the indication of the link property of the first link may include operations, features, means, or instructions for transmitting a first link quality indication to the network entity that indicates one or more link quality parameters of the first link. In some examples of the method, first UEs, and non-transitory computer-readable medium described herein, the one or more link quality parameters of the first link include one or more of a first link failure rate, a link failure rate variance, a link failure rate range, correlation in time of first link failures, a predicted failure probability of the first link, a latency of the first link, a signal strength of the first link, measured interference levels of the first link, or a channel contention success rate for the first link. In some examples of the method, first UEs, and non-transitory computer-readable medium described herein, the one or more link quality parameters may be transmitted to the network entity via one or more of a medium access control (MAC) control element (CE), radio resource control (RRC) signaling, uplink control information (UCI), or any combination thereof, and where one or more updates to the one or more link quality parameters may be transmitted based on a change in an associated value.

In some examples of the method, first UEs, and non-transitory computer-readable medium described herein, transmitting the indication of the link property of the first link may include operations, features, means, or instructions for transmitting a supportable data rate of the first link to the network entity. In some examples of the method, first UEs, and non-transitory computer-readable medium described herein, transmitting the indication of the link property of the first link may include operations, features, means, or instructions for transmitting an indication of a limit for a data rate associated with the second link based on a supportable data rate of the first link. In some examples of the method, first UEs, and non-transitory computer-readable medium described herein, transmitting the indication of the link property of the first link may include operations, features, means, or instructions for transmitting a first buffer status report (BSR) associated with the second UE that is separate from a second BSR associated with the first UE.

Some examples of the method, first UEs, and non-transitory computer-readable medium described herein may further include operations, features, means, or instructions for modifying a target block error rate of a radio link management procedure based on an estimated failure rate of the first link, where the target block error rate may be used for identifying a radio link failure associated with the second link.

A method for wireless communications by a network entity is described. The method may include receiving, from a first UE, an indication of a link property of a first link between the first UE and a second UE, where the second UE assists with communications between the first UE and the network entity and communicating with the first UE, via a second link between the network entity and both the first UE and the second UE, using one or more second link parameters that are based on the link property of the first link.

A network entity for wireless communications is described. The network entity may include one or more memories storing processor executable code, and one or more processors coupled with the one or more memories. The one or more processors may individually or collectively be operable to execute the code to cause the network entity to receive, from a first UE, an indication of a link property of a first link between the first UE and a second UE, where the second UE assists with communications between the first UE and the network entity and communicate with the first UE, via a second link between the network entity and both the first UE and the second UE, using one or more second link parameters that are based on the link property of the first link.

Another network entity for wireless communications is described. The network entity may include means for receiving, from a first UE, an indication of a link property of a first link between the first UE and a second UE, where the second UE assists with communications between the first UE and the network entity and means for communicating with the first UE, via a second link between the network entity and both the first UE and the second UE, using one or more second link parameters that are based on the link property of the first link.

A non-transitory computer-readable medium storing code for wireless communications is described. The code may include instructions executable by one or more processors to receive, from a first UE, an indication of a link property of a first link between the first UE and a second UE, where the second UE assists with communications between the first UE and the network entity and communicate with the first UE, via a second link between the network entity and both the first UE and the second UE, using one or more second link parameters that are based on the link property of the first link.

In some examples of the method, network entities, and non-transitory computer-readable medium described herein, receiving the indication of the link property of the first link may include operations, features, means, or instructions for receiving a first link failure indication from the first UE that indicates whether a link failure of the first link is associated with one or more downlink transport block communications to the first UE. In some examples of the method, network entities, and non-transitory computer-readable medium described herein, the first link failure indication may be provided in a multi-state ACK/NACK feedback indication associated with each of the one or more downlink transport block communications that indicates whether the first link experienced a failure associated with a corresponding downlink transport block communication. Some examples of the method, network entities, and non-transitory computer-readable medium described herein may further include operations, features, means, or instructions for determining a modulation and coding scheme (MCS) for one or more subsequent communications with the first UE based on the first link failure indication and transmitting the MCS to the first UE in control information associated with one or more subsequent communications via the second link.

In some examples of the method, network entities, and non-transitory computer-readable medium described herein, receiving the indication of the link property of the first link may include operations, features, means, or instructions for receiving a first link quality indication from the first UE that indicates one or more link quality parameters of the first link. In some examples of the method, network entities, and non-transitory computer-readable medium described herein, the one or more link quality parameters of the first link include one or more of a first link failure rate, a link failure rate variance, a link failure rate range, correlation in time of first link failures, a predicted failure probability of the first link, a latency of the first link, a signal strength of the first link, measured interference levels of the first link, or a channel contention success rate for the first link. Some examples of the method, network entities, and non-transitory computer-readable medium described herein may further include operations, features, means, or instructions for determining a MCS for one or more subsequent communications with the first UE based on the first link quality indication and transmitting the MCS to the first UE in control information associated with one or more subsequent communications via the second link.

In some examples of the method, network entities, and non-transitory computer-readable medium described herein, receiving the indication of the link property of the first link may include operations, features, means, or instructions for receiving an indication of a supportable data rate of the first link to the network entity. In some examples of the method, network entities, and non-transitory computer-readable medium described herein, receiving the indication of the link property of the first link may include operations, features, means, or instructions for receiving an indication of a limit for a data rate associated with the second link that is based on a supportable data rate of the first link.

In some examples of the method, network entities, and non-transitory computer-readable medium described herein, receiving the indication of the link property of the first link may include operations, features, means, or instructions for receiving a first BSR associated with the second UE that is separate from a second BSR associated with the first UE.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 through 3 show examples of wireless communications systems that supports techniques for user equipment cooperation in wireless communications in accordance with one or more aspects of the present disclosure.

FIG. 4 shows an example of a process flow that supports techniques for user equipment cooperation in wireless communications in accordance with one or more aspects of the present disclosure.

FIGS. 5 and 6 show block diagrams of devices that support techniques for user equipment cooperation in wireless communications in accordance with one or more aspects of the present disclosure.

FIG. 7 shows a block diagram of a communications manager that supports techniques for user equipment cooperation in wireless communications in accordance with one or more aspects of the present disclosure.

FIG. 8 shows a diagram of a system including a device that supports techniques for user equipment cooperation in wireless communications in accordance with one or more aspects of the present disclosure.

FIGS. 9 and 10 show block diagrams of devices that support techniques for user equipment cooperation in wireless communications in accordance with one or more aspects of the present disclosure.

FIG. 11 shows a block diagram of a communications manager that supports techniques for user equipment cooperation in wireless communications in accordance with one or more aspects of the present disclosure.

FIG. 12 shows a diagram of a system including a device that supports techniques for user equipment cooperation in wireless communications in accordance with one or more aspects of the present disclosure.

FIGS. 13 through 16 show flowcharts illustrating methods that support techniques for user equipment cooperation in wireless communications in accordance with one or more aspects of the present disclosure.

### DETAILED DESCRIPTION

In some wireless communications systems, a user equipment (UE) may communicate with a network entity via an access link (e.g., a Uu link) between the UE and the network entity. In some cases, channel conditions at the UE or a location of the UE may be a limiting factor on an amount of data that may be transferred between the UE and the network. In such cases, if a peer UE is in proximity to the UE, it has been proposed that the peer UE may assist the UE in communications with the network, using UE cooperation techniques in which a portion of data for a UE (which may be referred to as a ‘target UE’) may be communicated via a peer UE (which may be referred to as a ‘helper UE’). The target UE and the helper UE (or multiple helper UEs) may have a UE-to-UE connection (e.g., a PC5 connection, a Wi-Fi connection, etc.) and exchange data for which the helper UE assists in communications with the network. In some cases, the multiple UEs can form a virtual UE with additional antenna elements as compared to an individual UE, and a network entity may use multiple-input multiple-output (MIMO) communications techniques with the multiple UEs to enhance data rates. In existing proposals related to cooperative communications using multiple UEs, cooperation techniques assume that the UE-to-UE link is a perfect link, and the network entity may set communications parameters (e.g., modulation and coding scheme (MCS), hybris acknowledgment repeat request (HARQ) feedback timing, etc.) based on the virtual UE information. However, this may be problematic if a UE-to-UE link is imperfect, which may result in an MCS that is not supportable by the virtual UE and increased quantities of retransmissions.

In accordance with various aspects discussed herein, a target UE may provide information to a serving cell or serving network entity about a link quality of UE-to-UE links that are used in UE cooperation for communications. The network entity may use this information to adjust communications parameters with the target UE via a network-to-UE link (e.g., access link or Uu link) that uses multiple UEs. The adjusted parameters may include an adjusted MCS, adjusted feedback timing, and the like. The information about the link quality of the UE-to-UE link may include, for example, multi-state HARQ feedback that indicates acknowledgment/negative-acknowledgment (ACK/NACK) for a transport block (TB) and also indicates whether the UE-to-UE link or access link experienced a failure associated with the TB transmission. Additionally, or alternatively, the information about the link quality of the UE-to-UE link may be link capacity information, link failure rate information, link latency, link signal strength, link interference levels, or any combination thereof, which may be provided via signaling from the target UE (e.g., via a medium access control (MAC) control element (CE), radio resource control (RRC) signaling, uplink control information (UCI), or any combination thereof). In some aspects, for uplink communications, the information about the link quality of the UE-to-UE link may include separate buffer status reports (BSRs) for the target UE and for the one or more helper UEs. Additionally, or alternatively, radio link management (RLM) or radio link failure (RLF) procedures at the target UE may be adjusted to account for an imperfect UE-to-UE link.

Such techniques may provide for more efficient use of wireless resources for communications that utilize cooperative UEs, by reducing a quantity of retransmissions through adjustment of access link parameters based on link parameters of a UE-to-UE link. Such techniques may also provide for reduced power consumption at the UEs, reduced latency for communications, enhanced reliability, and an enhanced user experience.

Aspects of the disclosure are initially described in the context of wireless communications systems. Aspects of the disclosure are further illustrated by and described with reference to process flows, apparatus diagrams, system diagrams, and flowcharts that relate to techniques for user equipment cooperation in wireless communications.

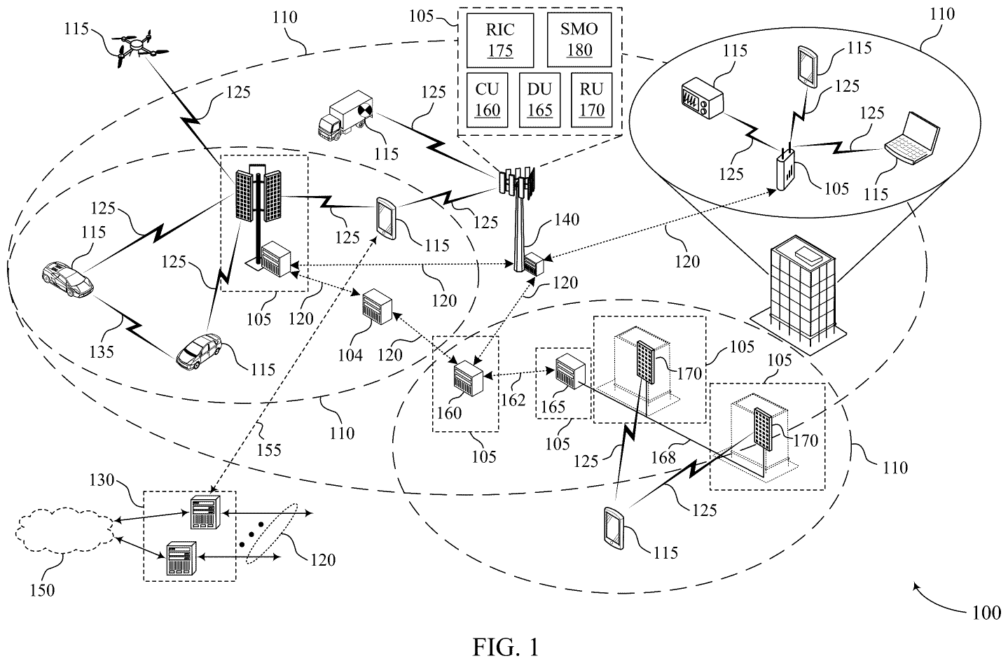

FIG. 1 shows an example of a wireless communications system 100 that supports techniques for user equipment cooperation in wireless communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support techniques for user equipment cooperation in wireless communications as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some aspects, two or more UEs 115 may participate in cooperative communications in which a first UE 115 (which may be an example of a target UE) and a second UE 115 (which may be an example of a helper UE) jointly communicate with a network entity 105 to provide communications for the first UE 115. In some aspects, a target UE 115 may provide information to a serving cell or serving network entity 105 about a link quality of UE-to-UE links that are used in UE cooperation communications. The network entity 105 may use this information to adjust communications parameters with the target UE via a network-to-UE link (e.g., a link 125) that uses multiple UEs. The adjusted parameters may include an adjusted MCS, adjusted feedback timing, and the like. In some aspects, for uplink communications, the information about the link quality of the UE-to-UE link may include separate BSRs for the target UE and for the one or more helper UEs. Additionally, or alternatively, RLM/RLF procedures at the target UE may be adjusted to account for an imperfect UE-to-UE link.

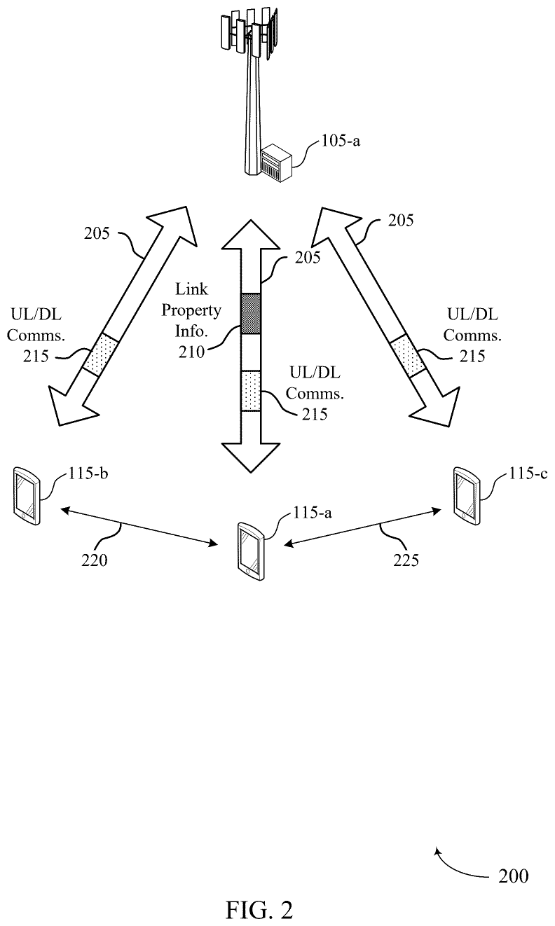

FIG. 2 shows an example of a wireless communications system 200 that supports techniques for user equipment cooperation in wireless communications in accordance with one or more aspects of the present disclosure. The wireless communications system 200 may implement or be implemented by aspects of the wireless communications system 100 as described herein with reference to FIG. 1. For example, the wireless communications system 200 may include a network entity 105-a, and multiple UEs 115 that may use cooperative UE communications with the network entity 105-a, including a first UE 115-a, a second UE 115-b, and a third UE 115-c. The UEs 115 and network entity 105-a may be examples of UEs 115 and network entities 105 as described herein with reference to FIG. 1. The wireless communications system 200 may support 3G, 4G, 5G, 6G, or radio access technologies beyond 6G.

The UEs 115 and the network entity 105-a may perform wireless communication (e.g., one or more of receiving, obtaining, transmitting, or outputting one or more of control information, configuration information, or data) via communication link 205, which may be an example of a cooperative communication link between network entity 105-a and multiple UEs 115. In this example, the first UE 115-a (which may be an example of a target UE) may receive assistance for uplink and/or downlink communications from the second UE 115-b and the third UE 115-c (which may be examples of helper UEs). In this example, the first UE 115-a and the second UE 115-b may have a UE-to-UE link 220, and the first UE 115-a and the third UE 115-c may have a UE-to-UE link 225. The UE-to-UE links 220, 225 may be, for example, sidelink connections (e.g., via a PC5 interface), Wi-Fi connections (e.g., in accordance with IEEE 802.11 protocols), or other wireless connections (e.g., Bluetooth or near-field connection). In some aspects, the first UE 115-a may determine a link quality associated with one or both of the UE-to-UE links 220, 225, and may report link property information 210 to the network entity 105-a. The network entity 105-a may use the link property information 210 to adjust one or more parameters of the communication link 205 for uplink and downlink communications 215 that are provided to the first UE 115-a jointly via the first UE 115-a, second UE 115-b, and third UE 115-c.

Such cooperative UE communication may allow for enhanced communications through aggregation of RF capability of the multiple UEs 115. For example, in some UE 115 form factors, baseband modem capabilities may higher than the RF capabilities (e.g., due to a quantity of antenna ports available), and UE relays allow creation of virtual UE with larger number of antennas, which can be exploited to increase user experience over the wireless communications system 200, and create a virtual MIMO effect. In some cases, the multiple UEs 115 may have a larger effective number of antennas, and may be seen as a “virtual UE” by the network entity 105-a or a UE with distributed panels or distributed antennas. The higher RF capability can provide benefits for both sub 7 GHz as well as mmW communications.

For downlink data transfer to the first UE 115-a, the multiple UEs 115 may use, in some cases, joint baseband processing may be used. In order to form the cooperative/virtual UE with joint baseband processing across distributed antennas from different individual UEs 115 that belong to the virtual UE, the UEs 115 may use I and Q exchange, where the second UE 115-b and third UE 115-c transmit the received signals (e.g. before or after FFT, but before demodulation/de-mapping) to the first UE 115-a, and the first UE 115-a performs joint demodulation/demapping and decoding. The UEs 115 may also use log likelihood ratio (LLR) exchange techniques, where the second UE 115-b and the third UE 115-c transmit LLR values (after demodulation/demapping) to the first UE 115-a, and the first UE 115-a performs joint decoding. In some cases, the UEs 115 may use separate baseband processing with TB exchange, where downlink data is delivered to the first UE 115-a as long as either the first UE 115-a or one of the second UE 115-b or third UE 115-c decodes the TB. For uplink data transfer, the first UE 115-a may send the UL data (e.g., TBs) to the second UE 115-b and third UE 115-c, for uplink transmission.

As discussed herein, in some proposals for cooperative UE communications, it is assumed that UE-to-UE link 220, 225 are high quality and reliable links, or not directly in scope of Uu procedures. However, in some deployments the UE-to-UE link 220, 225 may be sources of potential failures, such as due to interference. In some cases, UE cooperation may transparent to the network entity 105-a in the sense that the network entity 105-a communicates with a virtual UE, and in such cases various techniques discussed herein may be from a virtual UE point of view. In other cases, the network entity 105-a may maintain separate Uu links with each individual UE 115, and is aware of the fact that the UEs 115 belong to a cooperation set, and in such cases various techniques discussed herein may be from a point of view of the first UE 115-a.

In some aspects, the first UE 115-a may be configured to send the link property information 210 that indicates UE-to-UE link failures as part of HARQ-ACK feedback. In some examples, the first UE 115-a may transmit a multi-state HARQ-ACK feedback for each physical downlink shared channel (PDSCH) downlink TB. In one example, the multi-state HARQ-ACK feedback may may include four states:
State 1 (00): ACK despite a UE-to-UE link failure
State 2 (01): ACK with help (i.e., UE-to-UE link did not fail)
State 3 (10): NACK even with help (even though UE-to-UE link did not fail)
State 4 (11): NACK due to UE-to-UE link failure

In other examples, for each PDSCH TB, the first UE 115-a may send a single-bit ACK/NNACK indication, and a one-bit ACK/NACK on UE-to-UE link status, for the purpose of decoding the scheduled TB via UE cooperation.

In some aspects, the network entity 105-a may have different outer loop behaviors for adjusting a downlink modulation and coding scheme (MCS) based on the provided. feedback. For example, if a NACK is due to UE-to-UE link failure and under the assumption that such failure is not persistent, the network entity 105-a may maintain a current MCS, but if a NACK is even with help the network entity 105-a may reduce the MCS. In another example, if an ACK is despite a UE-to-UE link failure, and under the assumption that such failure is not persistent, an MCS may be increased more aggressively compared to the case where an ACK is with help. Further, in the network entity 105-a observes persistent UE-to-UE link failures, it can reduce the MCS to a target communication rate without UE cooperation (i.e., switch to no UE cooperation).

In some aspects, the first UE 115-a may be configured to send information on UE-to-UE link quality with respect to UE-to-UE link failure rates. For example, the first UE 115-a may report at least the average UE-to-UE link failure rate, and may also include a variance, range, correlation in time (e.g., burstiness of failures), predicted failure probability for a duration in the future, or any combination thereof. In some cases, the UE may report link property information 210 with respect to UE-to-UE link latency, which may include at least an average latency, and may also include variance, range, correlation in time (e.g., burstiness of large latency), predicted latency for a duration in the future, or any combination thereof. Additionally, or alternatively, the link property information 210 may provide received signal strength indication (RSSI) (e.g., used for Wi-Fi), reference signal received power (RSRP), signal-to-interference-and-noise ratio (SINR), listen before talk (LBT) success/failure rate (e.g., for Wi-Fi or shared spectrum communications), interference levels, or any combination thereof. In some cases, the link property information 210 may be provided in a MAC-CE, in RRC signaling, as part of UCI, or any combination thereof. Further, the link property information 210 may be updated by the first UE 115-a upon change (e.g., when a reported parameter changes by a configured or defined threshold value).

As discussed herein, the network entity 105-a may adjust one or more parameters, such as MCS, based on the reported information, as well as channel state information and other HARQ feedback. In some examples, assume that from CSI, R₁ is the communication rate in the presence of a helper UE; R₀ is the communication rate in the absence of the helper UE, and from the link property information 210 e is the UE-to-UE average link failure. In such cases, if the network entity 105-a knows a priori (e.g., can predict or obtain such a prediction from the UE) whether a UE-to-UE link will fail or not, it can choose the MCS/rank accordingly to achieve overall rate e R₀+(1−e)R₁. Further, the ACK/NACK based outer loop to achieve a certain block error rate (BLER) target may be separate between scheduling instances with the assumption of with and without a helper UE. Otherwise, the network entity 105-a may choose MCS/rank according to R₁ or R₀ to achieve overall rate max (R₀, (1−e)R₁). For example, if e≤1−R₀/R₁, then the MCS/rank may be selected based on R₁. In this case, the UE-to-UE average link failure rate may be discounted (e.g., when NACK is due to UE-to-UE failure, it does not bring the MCS down). That is, the network entity 105-a may adjust the MCS to achieve on average a ratio of e+e₀ NACKs to number of transmissions when e₀ is the target BLER (e.g., 10%). In other words, actual BLER of e+e₀ should be tolerated for the target BLER of e₀. Further, if e>1−R₀/R₁, then MCS/rank may be selected based on R₀. In some aspects, the network entity 105-a may choose the PUCCH resource for HARQ-ACK feedback based on the reported information (e.g., on UE-to-UE link latency). For example, when an average/predicted UE-to-UE link latency is large, a larger K1 value (e.g., a HARQ-ACK feedback slot offset with respect to a PDSCH slot) may be indicated by a scheduling downlink control information (DCI) to allow for more time to decode the PDSCH cooperatively.

In some aspects, when the UE-to-UE communication is capacity-limited, the first UE 115-a may provide an indication of such a limitation to the network entity 105-a. For example, the indication may be provided in the form of a maximum UE-to-UE data rate for reliable UE-to-UE communication. Alternatively, such a limitation may be translated to a limitation on the access link with UE cooperation assumption, and reported to the network entity 105-a (e.g., the larger a downlink or uplink TB is on the access link, the higher a requirement on the UE-to-UE link(s) for UE cooperation). In some cases, the first UE 115-a may indicate a maximum access link data rate (e.g., TBS/MCS/BW/rank) given the constraint on the maximum UE-to-UE link rate. This information may be separately indicated for downlink versus uplink. For downlink, the dependency of maximum access link rate on the maximum UE-to-UE link rate may be a function of whether UE cooperation is with joint baseband processing (e.g., I/Q exchange or LLR exchange) or is with separate baseband processing (e.g., TB exchange). For uplink, only TB exchange is needed, and I/Q exchange may not be necessary. Such a limitation can be also associated with a UE-to-UE average link failure (e.g., statistics of UE-to-UE link failure). For example, the first UE 115-a may report a UE-to-UE average link rate e₁ for a first maximum UE-to-UE or access link data rate and UE-to-UE average link rate e₂ for a second maximum UE-to-UE or access link data rate.

In some aspects, the first UE 115-a may perform RLM/RLF based on the UE-to-UE links. In some cases, the first UE 115-a may monitor a RLM reference signal (RS) to identify whether downlink a radio link quality of the network entity 105-a (e.g., a PCell and PSCell) falls below a threshold. In some cases, this may be evaluated based on a hypothetical PDCCH BLER of 10%. In cases of UE cooperation and with imperfect UE-to-UE links, if such evaluation of PDCCH BLER based on RLM-RS when a RS is received from both UEs, the first UE 115-a may account for UE-to-UE average link failure. In some aspects, tor the RLM/RLF procedure with UE cooperation, the target hypothetical PDCCH BLER may be reduced to account for UE-to-UE link failure. If the hypothetical PDCCH BLER is x % without UE cooperation, y % with UE cooperation (which is the one UE uses to declare RLF/RLM), with UE-to-UE average link failure e, the actual average hypothetical PDCCH BLER is e·x+(1−e)y %. To achieve 10% actual average hypothetical PDCCH BLER, the hypothetical PDCCH BLER with UE cooperation should be

$$y = \frac{10 - e \cdot x}{1 - e} \% ,$$

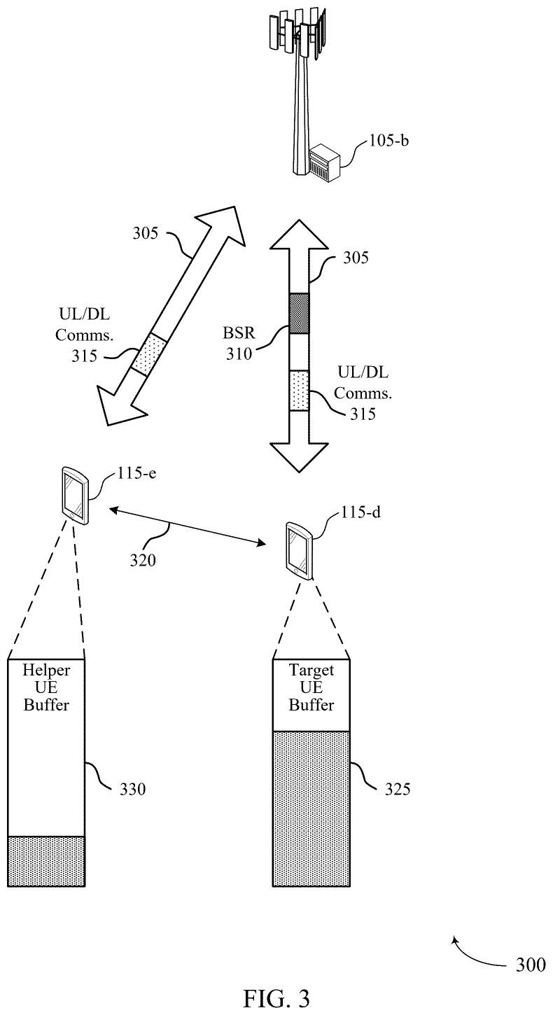

which is smaller than 10% if e>0 and given that x≥y (e.g., UE cooperation decreases the PDCCH BLER). In some cases, the availability of a helper UE may be dependent on a state of the helper UE, and FIG. 3 shows an example of buffer status report (BSR) indication techniques.

FIG. 3 shows an example of a wireless communications system 300 that supports techniques for user equipment cooperation in wireless communications in accordance with one or more aspects of the present disclosure. The wireless communications system 300 may implement or be implemented by aspects of the wireless communications system 100 and 200 as described herein with reference to FIGS. 1 and 2. For example, the wireless communications system 300 may include a network entity 105-b, and multiple UEs 115 that may use cooperative UE communications with the network entity 105-b, including a first UE 115-d and a second UE 115-e. The UEs 115 and network entity 105-b may be examples of UEs 115 and network entities 105 as described herein with reference to FIGS. 1 and 2. The wireless communications system 300 may support 3G, 4G, 5G, 6G, or radio access technologies beyond 6G.

The UEs 115 and the network entity 105-b may perform wireless communication (e.g., one or more of receiving, obtaining, transmitting, or outputting one or more of control information, configuration information, or data) via communication link 305, which may be an example of a cooperative communication link between network entity 105-b and multiple UEs 115. In this example, the first UE 115-d (which may be an example of a target UE) may receive assistance for uplink and/or downlink communications from the second UE 115-e (which may be an example of a helper UE). In this example, the first UE 115-d and the second UE 115-e may have a UE-to-UE link 320. The UE-to-UE link 320 may be, for example, a sidelink connection (e.g., via a PC5 interface), Wi-Fi connection (e.g., in accordance with IEEE 802.11 protocols), or other wireless connection (e.g., Bluetooth or near-field connection). In some aspects, the first UE 115-d may determine a link quality associated with the UE-to-UE link 320 based on a target UE buffer 325 status and a helper UE buffer 330 status, and may report link quality information as a BSR 310 to the network entity 105-b. The network entity 105-b may use the BSR 310 to adjust one or more parameters of the communication link 305 for uplink and downlink communications 315 that are provided to the first UE 115-d jointly via the first UE 115-d and second UE 115-e.

For uplink communications, whether UE-cooperation can be assumed or not may depend on an availability of uplink packets at the second UE 115-e, which itself may depend on the quality (e.g., capacity/latency) of the UE-to-UE link 320. For example, at a given time, the first UE 115-d may have 10 MB of uplink data in the target UE buffer 325 to transmit, but only 5 MB of this is made available to the second UE 115-e through UE-to-UE communication. In legacy deployments, a BSR report indicates the amount of uplink data from which the network can know how many uplink grants should be scheduled for PUSCHs. However, with cooperative UE transmissions, the BSR (originated from the first UE 115-d) can be different at the first UE 115-d versus the second UE 115-c.

In accordance with various aspects, the first UE 115-d may provide additional BSR information for a remote antenna panel or remote set of antennas (that is, associated with the second UE 115-c) in addition its own BSR. In some cases, the triggering for reporting the first UE 115-d BSR and additional BSR can be the same or separate. The reporting of the first UE 115-d BSR and the additional BSR can be joint (e.g., as part of the same BSR MAC-CE) or separate. The network entity 105-b may determine which scheduled PUSCH can be transmitted with cooperation (that is, from both UEs 115) and without cooperation (that is, only from the first UE 115-d). This may impact selection of transmission parameters for scheduling a corresponding PUSCH, such as MCS, rank, precoding, power control, or any combination thereof.

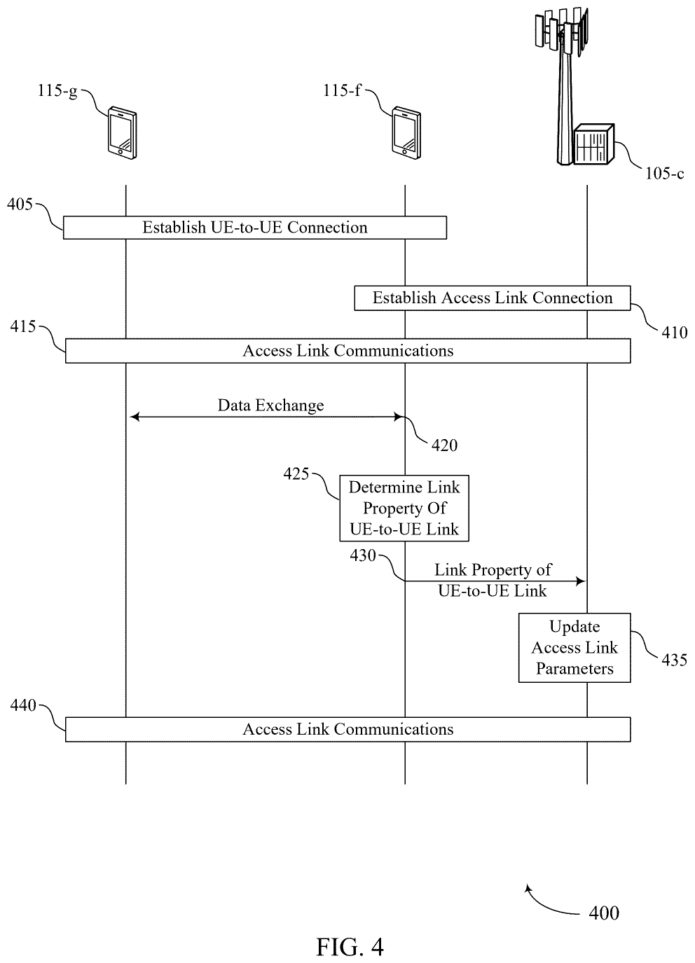

FIG. 4 shows an example of a process flow 400 that supports techniques for user equipment cooperation in wireless communications in accordance with one or more aspects of the present disclosure. The process flow 400 may include a network entity 105-c, a first UE 115-f (which may be an example of a target UE), and a second UE 115-g (which may be an example of a helper UE), which may be examples of network entities and UEs as described with reference to FIGS. 1 through 3. The process flow 400 may be implemented by the network entity 105-c, the first UE 115-f, and second UE 115-g when cooperative UE communications are enables. Such techniques may provide for enhanced reliability, reduced latency, and efficient communications with the first UE 115-f, which may thereby enhance overall network efficiency and user experience. In the following description of the process flow 400, the operations between the network entity 105-c, the first UE 115-f, and the second UE 115-g may be performed in a different order than the example order shown. Some operations may be omitted from the process flow 400, and other operations may be added to the process flow 400.

At 405, the first UE 115-f and the second UE 115-g may establish a UE-to-UE connection. In some cases, the UE-to-UE connection may be a 3GPP-based connection, such as a sidelink connection via the PC5 interface. In other cases, the UE-to-UE connection may be a non-3GPP connection, such as a Wi-Fi connection. The first UE 115-f and the second UE 115-g may perform device discovery and connection establishment in accordance with the particular type of connection between the UEs 115.

At 410, the first UE 115-f may establish an access link connection with the network entity 105-c. The access link connection may be established in accordance with RRC connection establishment or reestablishment techniques. In some cases, the access link may use multiple antennas or antenna panels associated with the UEs 115. In some cases, the network entity 105-c may be aware of the cooperative UE communications and which UEs 115 are associated with the access link.

At 415, the network entity 105-c, the first UE 115-f, and the second UE 115-g may participate in access link communications using cooperative UE communications. As part of the cooperative UE communications, at 420, the first UE 115-f and the second UE 115-g may exchange data associated with the access link communications.

At 425, the first UE 115-f may determine one or more link properties of the UE-to-UE link. As discussed herein, such link properties may include HARQ ACK/NACK feedback, signal strength, link failure rate, link latency, BSRs of the UEs 115, measured interference levels, channel contention success rates, or any combination thereof. At 430, the first UE 115-f may transmit, and the network entity 105-c may receive, link property information of the UE-to-UE link.

At 435, the network entity 105-c may update one or more access link parameters based on the indicated link property of the UE-to-UE link. For example, the network entity 105-c may adjust a MCS, rank, precoding, power control, resource scheduling, or any combination thereof. At 440, the network entity 105-c, the first UE 115-f, and the second UE 115-g may participate in access link communications using cooperative UE communications, using the updated access link parameters.

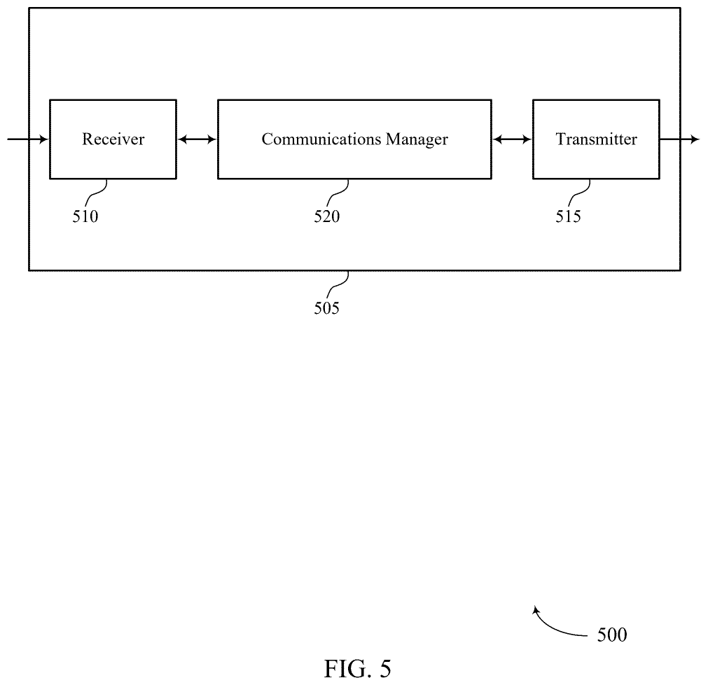

FIG. 5 shows a block diagram 500 of a device 505 that supports techniques for user equipment cooperation in wireless communications in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for user equipment cooperation in wireless communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for user equipment cooperation in wireless communications). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of techniques for user equipment cooperation in wireless communications as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for determining a link property of a first link between the first UE and a second UE, where the second UE assists with communications between the first UE and a network entity. The communications manager 520 is capable of, configured to, or operable to support a means for transmitting an indication of the link property of the first link to the network entity via a second link between the first UE and the network entity. The communications manager 520 is capable of, configured to, or operable to support a means for communicating with the network entity, via the second link using one or more second link parameters that are based on the link property of the first link.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for cooperative UE communications that provide for more efficient use of wireless resources, reduced power consumption at the UEs, reduced latency for communications, enhanced reliability, and an enhanced user experience.

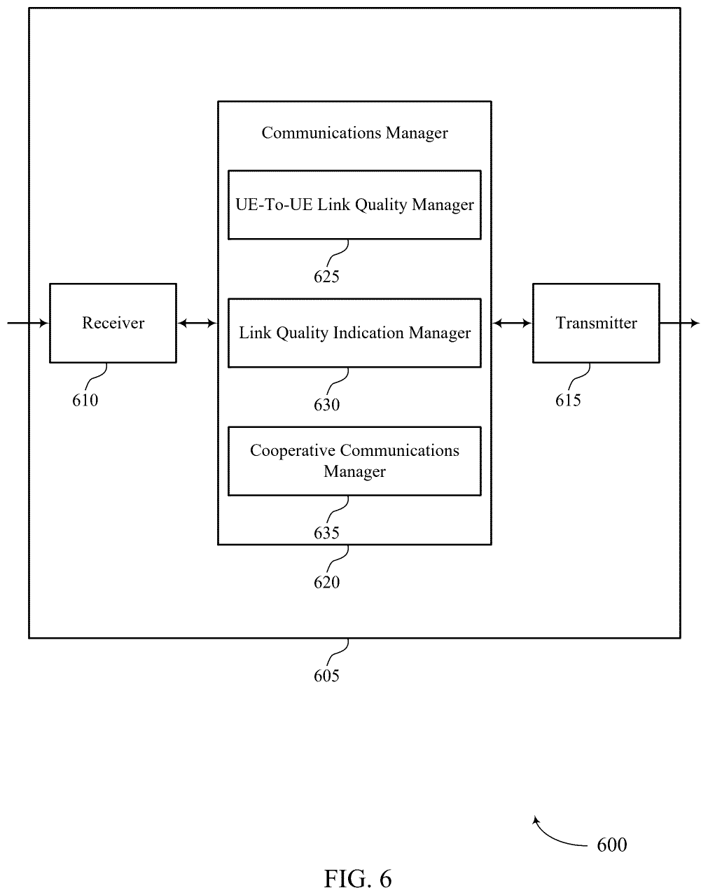

FIG. 6 shows a block diagram 600 of a device 605 that supports techniques for user equipment cooperation in wireless communications in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for user equipment cooperation in wireless communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for user equipment cooperation in wireless communications). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for user equipment cooperation in wireless communications as described herein. For example, the communications manager 620 may include a UE-to-UE link quality manager 625, a link quality indication manager 630, a cooperative communications manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The UE-to-UE link quality manager 625 is capable of, configured to, or operable to support a means for determining a link property of a first link between the first UE and a second UE, where the second UE assists with communications between the first UE and a network entity. The link quality indication manager 630 is capable of, configured to, or operable to support a means for transmitting an indication of the link property of the first link to the network entity via a second link between the first UE and the network entity. The cooperative communications manager 635 is capable of, configured to, or operable to support a means for communicating with the network entity, via the second link using one or more second link parameters that are based on the link property of the first link.

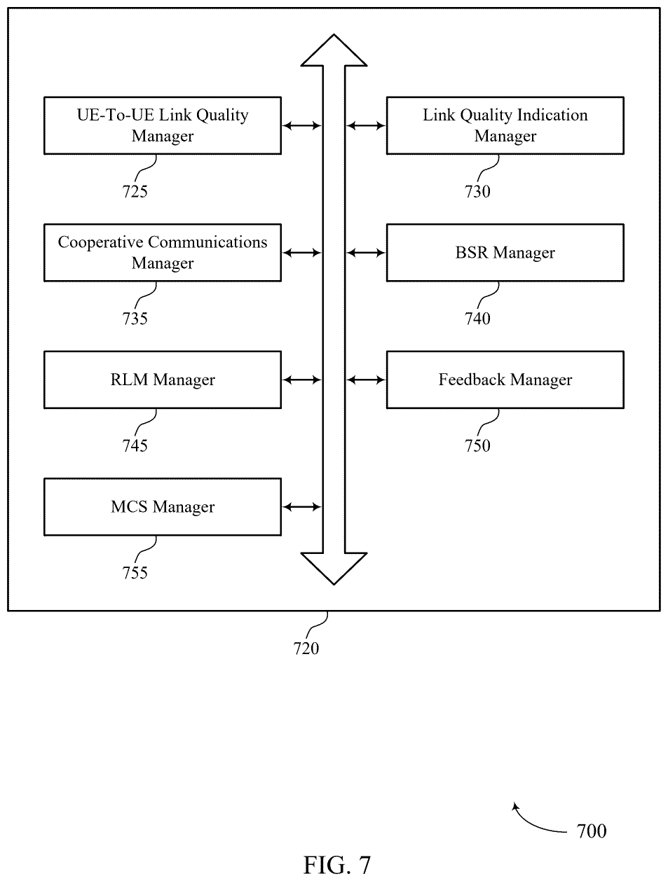

FIG. 7 shows a block diagram 700 of a communications manager 720 that supports techniques for user equipment cooperation in wireless communications in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for user equipment cooperation in wireless communications as described herein. For example, the communications manager 720 may include a UE-to-UE link quality manager 725, a link quality indication manager 730, a cooperative communications manager 735, an BSR manager 740, an RLM manager 745, a feedback manager 750, an MCS manager 755, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The UE-to-UE link quality manager 725 is capable of, configured to, or operable to support a means for determining a link property of a first link between the first UE and a second UE, where the second UE assists with communications between the first UE and a network entity. The link quality indication manager 730 is capable of, configured to, or operable to support a means for transmitting an indication of the link property of the first link to the network entity via a second link between the first UE and the network entity. The cooperative communications manager 735 is capable of, configured to, or operable to support a means for communicating with the network entity, via the second link using one or more second link parameters that are based on the link property of the first link.

In some examples, to support transmitting the indication of the link property of the first link, the link quality indication manager 730 is capable of, configured to, or operable to support a means for transmitting a first link failure indication to the network entity that indicates whether a link failure of the first link is associated with one or more downlink transport block communications from the network entity. In some examples, the first link failure indication is provided in a multi-state ACK/NACK feedback indication associated with each of the one or more downlink transport block communications that indicates whether the first link experienced a failure associated with a corresponding downlink transport block communication.

In some examples, to support transmitting the indication of the link property of the first link, the link quality indication manager 730 is capable of, configured to, or operable to support a means for transmitting a first link quality indication to the network entity that indicates one or more link quality parameters of the first link. In some examples, the one or more link quality parameters of the first link include one or more of a first link failure rate, a link failure rate variance, a link failure rate range, correlation in time of first link failures, a predicted failure probability of the first link, a latency of the first link, a signal strength of the first link, measured interference levels of the first link, or a channel contention success rate for the first link. In some examples, the one or more link quality parameters are transmitted to the network entity via one or more of a MAC-CE, RRC signaling, UCI, or any combination thereof, and where one or more updates to the one or more link quality parameters are transmitted based on a change in an associated value.

In some examples, to support transmitting the indication of the link property of the first link, the link quality indication manager 730 is capable of, configured to, or operable to support a means for transmitting a supportable data rate of the first link to the network entity. In some examples, to support transmitting the indication of the link property of the first link, the link quality indication manager 730 is capable of, configured to, or operable to support a means for transmitting an indication of a limit for a data rate associated with the second link based on a supportable data rate of the first link.

In some examples, to support transmitting the indication of the link property of the first link, the BSR manager 740 is capable of, configured to, or operable to support a means for transmitting a first buffer status report (BSR) associated with the second UE that is separate from a second BSR associated with the first UE.

In some examples, the RLM manager 745 is capable of, configured to, or operable to support a means for modifying a target block error rate of a radio link management procedure based on an estimated failure rate of the first link, where the target block error rate is used for identifying a radio link failure associated with the second link.

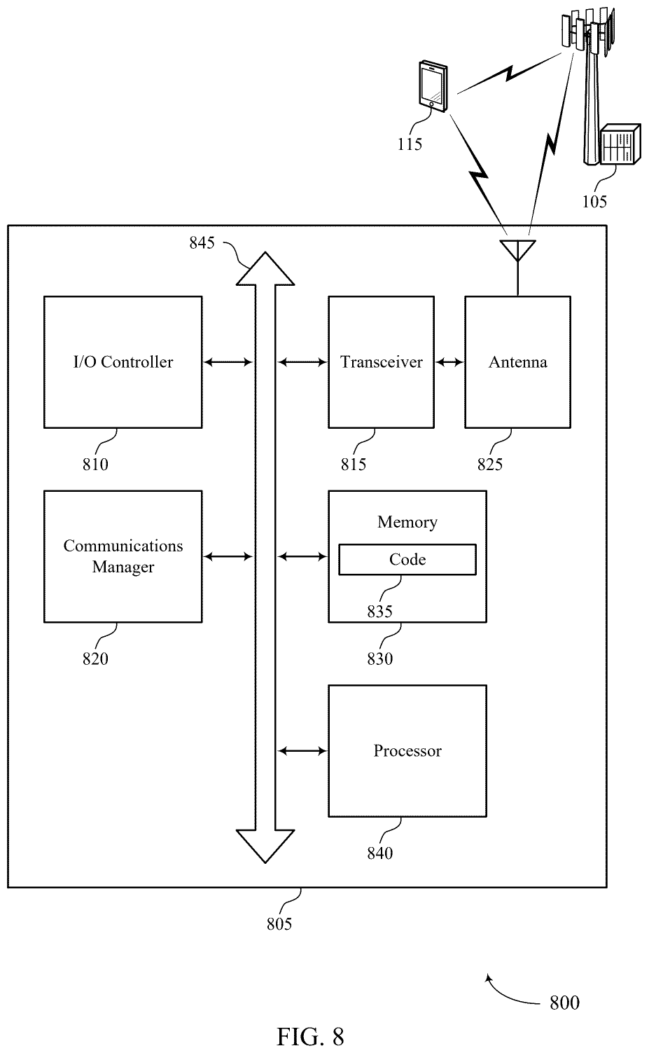

FIG. 8 shows a diagram of a system 800 including a device 805 that supports techniques for user equipment cooperation in wireless communications in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for user equipment cooperation in wireless communications). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for determining a link property of a first link between the first UE and a second UE, where the second UE assists with communications between the first UE and a network entity. The communications manager 820 is capable of, configured to, or operable to support a means for transmitting an indication of the link property of the first link to the network entity via a second link between the first UE and the network entity. The communications manager 820 is capable of, configured to, or operable to support a means for communicating with the network entity, via the second link using one or more second link parameters that are based on the link property of the first link.

Additionally, or alternatively, the communications manager 820 may support wireless communications in accordance with examples as disclosed herein. For example, the communications manager 820 is capable of, configured to, or operable to support a means for receiving, from a first UE, an indication of a link property of a first link between the first UE and a second UE, where the second UE assists with communications between the first UE and the network entity. The communications manager 820 is capable of, configured to, or operable to support a means for communicating with the first UE, via a second link between the network entity and both the first UE and the second UE, using one or more second link parameters that are based on the link property of the first link.

By including or configuring the communications manager 820 in accordance with examples as described herein, the device 805 may support techniques for cooperative UE communications that provide for more efficient use of wireless resources, reduced power consumption at the UEs, reduced latency for communications, enhanced reliability, and an enhanced user experience.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for user equipment cooperation in wireless communications as described herein, or the at least one processor 840 and the at least one memory 830 may be otherwise configured to, individually or collectively, perform or support such operations.

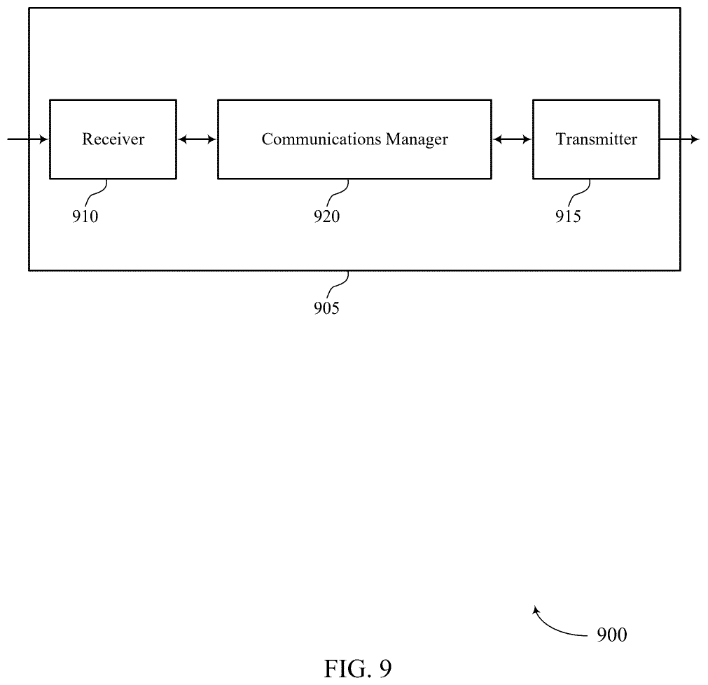

FIG. 9 shows a block diagram 900 of a device 905 that supports techniques for user equipment cooperation in wireless communications in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of techniques for user equipment cooperation in wireless communications as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving, from a first UE, an indication of a link property of a first link between the first UE and a second UE, where the second UE assists with communications between the first UE and the network entity. The communications manager 920 is capable of, configured to, or operable to support a means for communicating with the first UE, via a second link between the network entity and both the first UE and the second UE, using one or more second link parameters that are based on the link property of the first link.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for cooperative UE communications that provide for more efficient use of wireless resources, reduced power consumption at the UEs, reduced latency for communications, enhanced reliability, and an enhanced user experience.

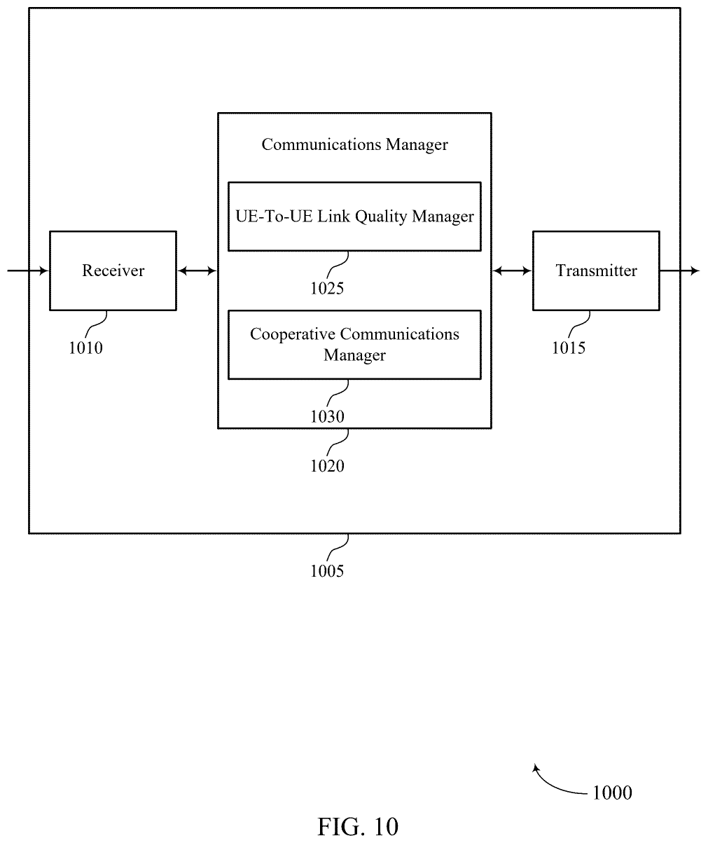

FIG. 10 shows a block diagram 1000 of a device 1005 that supports techniques for user equipment cooperation in wireless communications in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one of more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for user equipment cooperation in wireless communications as described herein. For example, the communications manager 1020 may include a UE-to-UE link quality manager 1025 a cooperative communications manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The UE-to-UE link quality manager 1025 is capable of, configured to, or operable to support a means for receiving, from a first UE, an indication of a link property of a first link between the first UE and a second UE, where the second UE assists with communications between the first UE and the network entity. The cooperative communications manager 1030 is capable of, configured to, or operable to support a means for communicating with the first UE, via a second link between the network entity and both the first UE and the second UE, using one or more second link parameters that are based on the link property of the first link.

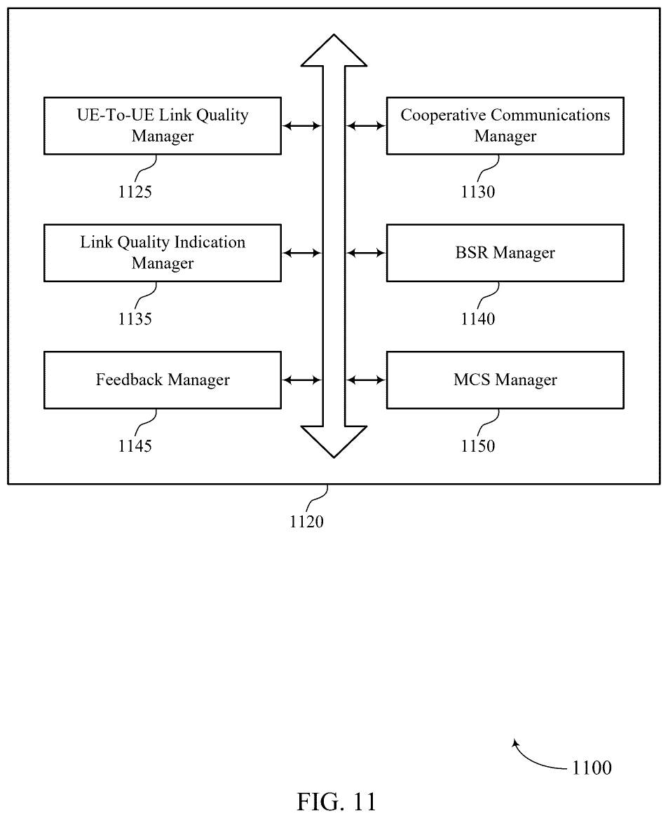

FIG. 11 shows a block diagram 1100 of a communications manager 1120 that supports techniques for user equipment cooperation in wireless communications in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for user equipment cooperation in wireless communications as described herein. For example, the communications manager 1120 may include a UE-to-UE link quality manager 1125, a cooperative communications manager 1130, a link quality indication manager 1135, an BSR manager 1140, a feedback manager 1145, an MCS manager 1150, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The UE-to-UE link quality manager 1125 is capable of, configured to, or operable to support a means for receiving, from a first UE, an indication of a link property of a first link between the first UE and a second UE, where the second UE assists with communications between the first UE and the network entity. The cooperative communications manager 1130 is capable of, configured to, or operable to support a means for communicating with the first UE, via a second link between the network entity and both the first UE and the second UE, using one or more second link parameters that are based on the link property of the first link.

In some examples, to support receiving the indication of the link property of the first link, the link quality indication manager 1135 is capable of, configured to, or operable to support a means for receiving a first link failure indication from the first UE that indicates whether a link failure of the first link is associated with one or more downlink transport block communications to the first UE. In some examples, the first link failure indication is provided in a multi-state ACK/NACK feedback indication associated with each of the one or more downlink transport block communications that indicates whether the first link experienced a failure associated with a corresponding downlink transport block communication.

In some examples, the MCS manager 1150 is capable of, configured to, or operable to support a means for determining a MCS for one or more subsequent communications with the first UE based on the first link failure indication. In some examples, the MCS manager 1150 is capable of, configured to, or operable to support a means for transmitting the MCS to the first UE in control information associated with one or more subsequent communications via the second link.

In some examples, to support receiving the indication of the link property of the first link, the link quality indication manager 1135 is capable of, configured to, or operable to support a means for receiving a first link quality indication from the first UE that indicates one or more link quality parameters of the first link. In some examples, the one or more link quality parameters of the first link include one or more of a first link failure rate, a link failure rate variance, a link failure rate range, correlation in time of first link failures, a predicted failure probability of the first link, a latency of the first link, a signal strength of the first link, measured interference levels of the first link, or a channel contention success rate for the first link.

In some examples, the MCS manager 1150 is capable of, configured to, or operable to support a means for determining a MCS for one or more subsequent communications with the first UE based on the first link quality indication. In some examples, the MCS manager 1150 is capable of, configured to, or operable to support a means for transmitting the MCS to the first UE in control information associated with one or more subsequent communications via the second link.

In some examples, to support receiving the indication of the link property of the first link, the link quality indication manager 1135 is capable of, configured to, or operable to support a means for receiving an indication of a supportable data rate of the first link to the network entity. In some examples, to support receiving the indication of the link property of the first link, the link quality indication manager 1135 is capable of, configured to, or operable to support a means for receiving an indication of a limit for a data rate associated with the second link that is based on a supportable data rate of the first link.

In some examples, to support receiving the indication of the link property of the first link, the BSR manager 1140 is capable of, configured to, or operable to support a means for receiving a first buffer status report (BSR) associated with the second UE that is separate from a second BSR associated with the first UE.

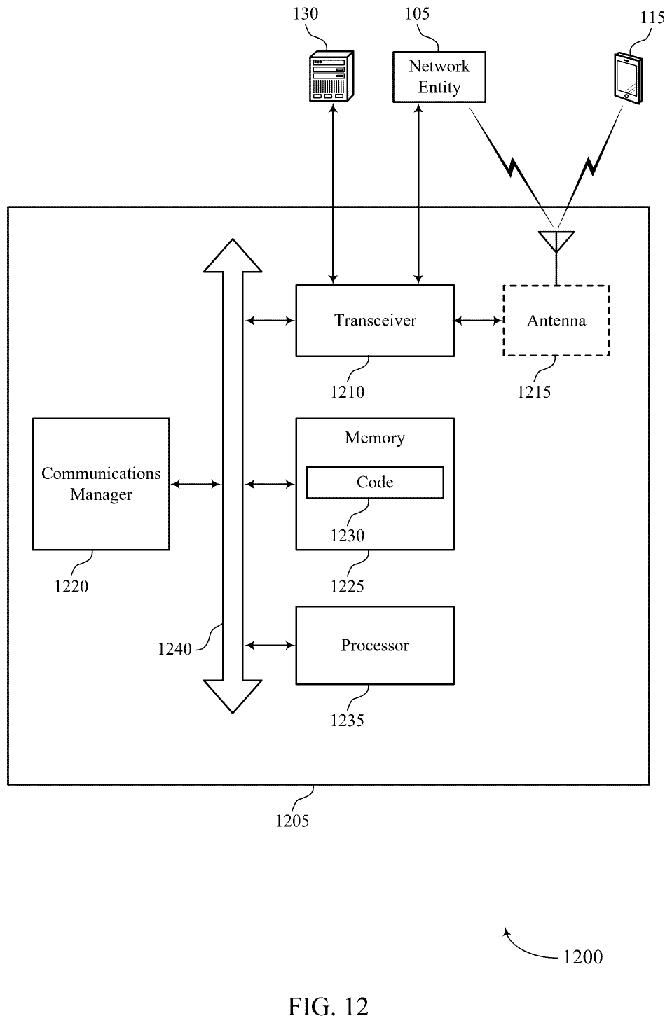

FIG. 12 shows a diagram of a system 1200 including a device 1205 that supports techniques for user equipment cooperation in wireless communications in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting techniques for user equipment cooperation in wireless communications). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for receiving, from a first UE, an indication of a link property of a first link between the first UE and a second UE, where the second UE assists with communications between the first UE and the network entity. The communications manager 1220 is capable of, configured to, or operable to support a means for communicating with the first UE, via a second link between the network entity and both the first UE and the second UE, using one or more second link parameters that are based on the link property of the first link.

By including or configuring the communications manager 1220 in accordance with examples as described herein, the device 1205 may support techniques for cooperative UE communications that provide for more efficient use of wireless resources, reduced power consumption at the UEs, reduced latency for communications, enhanced reliability, and an enhanced user experience.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of techniques for user equipment cooperation in wireless communications as described herein, or the at least one processor 1235 and the at least one memory 1225 may be otherwise configured to, individually or collectively, perform or support such operations.

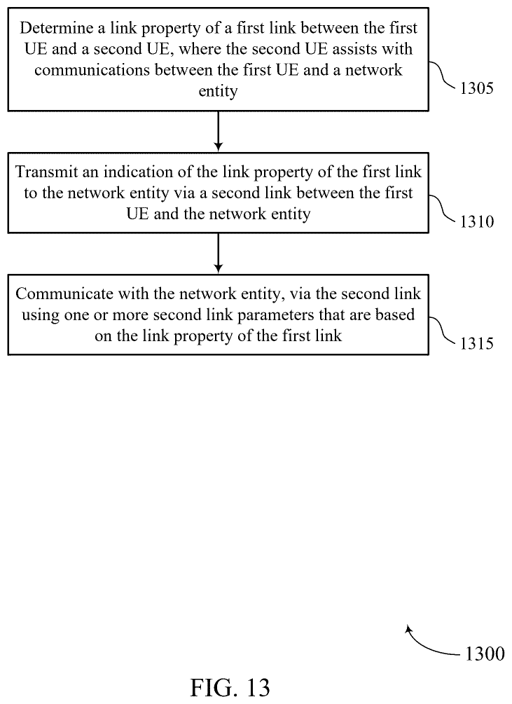

FIG. 13 shows a flowchart illustrating a method 1300 that supports techniques for user equipment cooperation in wireless communications in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include determining a link property of a first link between the first UE and a second UE, where the second UE assists with communications between the first UE and a network entity. The operations of 1305 may be performed in accordance with examples as disclosed herein. In some examples, aspects of the operations of 1305 may be performed by a UE-to-UE link quality manager 725 as described with reference to FIG. 7.

At 1310, the method may include transmitting an indication of the link property of the first link to the network entity via a second link between the first UE and the network entity. The operations of 1310 may be performed in accordance with examples as disclosed herein. In some examples, aspects of the operations of 1310 may be performed by a link quality indication manager 730 as described with reference to FIG. 7.

At 1315, the method may include communicating with the network entity, via the second link using one or more second link parameters that are based on the link property of the first link. The operations of 1315 may be performed in accordance with examples as disclosed herein. In some examples, aspects of the operations of 1315 may be performed by a cooperative communications manager 735 as described with reference to FIG. 7.

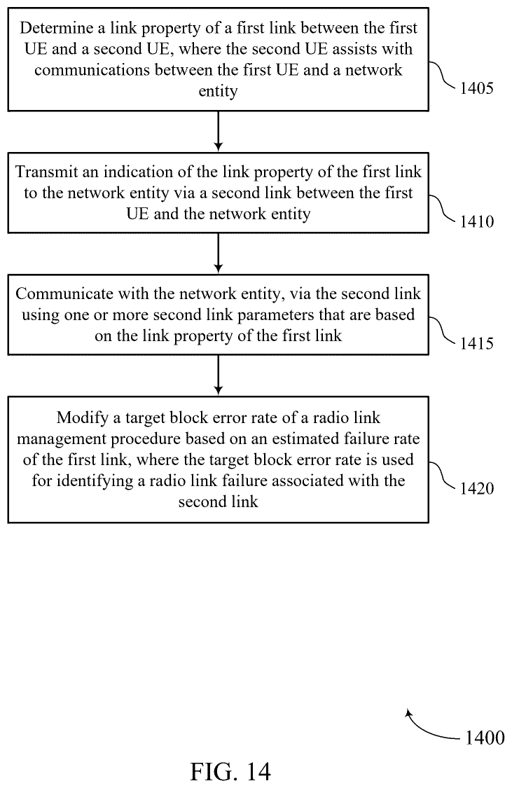

FIG. 14 shows a flowchart illustrating a method 1400 that supports techniques for user equipment cooperation in wireless communications in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include determining a link property of a first link between the first UE and a second UE, where the second UE assists with communications between the first UE and a network entity. The operations of 1405 may be performed in accordance with examples as disclosed herein. In some examples, aspects of the operations of 1405 may be performed by a UE-to-UE link quality manager 725 as described with reference to FIG. 7.

At 1410, the method may include transmitting an indication of the link property of the first link to the network entity via a second link between the first UE and the network entity. The operations of 1410 may be performed in accordance with examples as disclosed herein. In some examples, aspects of the operations of 1410 may be performed by a link quality indication manager 730 as described with reference to FIG. 7.

At 1415, the method may include communicating with the network entity, via the second link using one or more second link parameters that are based on the link property of the first link. The operations of 1415 may be performed in accordance with examples as disclosed herein. In some examples, aspects of the operations of 1415 may be performed by a cooperative communications manager 735 as described with reference to FIG. 7.

At 1420, the method may include modifying a target block error rate of a radio link management procedure based on an estimated failure rate of the first link, where the target block error rate is used for identifying a radio link failure associated with the second link. The operations of 1420 may be performed in accordance with examples as disclosed herein. In some examples, aspects of the operations of 1420 may be performed by an RLM manager 745 as described with reference to FIG. 7.

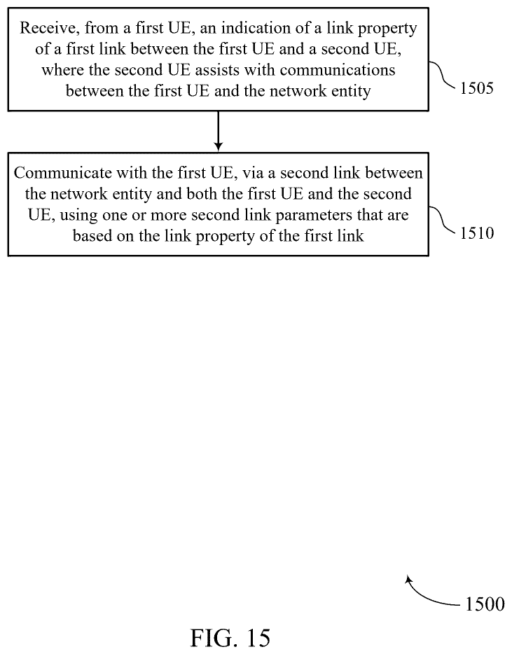

FIG. 15 shows a flowchart illustrating a method 1500 that supports techniques for user equipment cooperation in wireless communications in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include receiving, from a first UE, an indication of a link property of a first link between the first UE and a second UE, where the second UE assists with communications between the first UE and the network entity. The operations of 1505 may be performed in accordance with examples as disclosed herein. In some examples, aspects of the operations of 1505 may be performed by a UE-to-UE link quality manager 1125 as described with reference to FIG. 11.

At 1510, the method may include communicating with the first UE, via a second link between the network entity and both the first UE and the second UE, using one or more second link parameters that are based on the link property of the first link. The operations of 1510 may be performed in accordance with examples as disclosed herein. In some examples, aspects of the operations of 1510 may be performed by a cooperative communications manager 1130 as described with reference to FIG. 11.

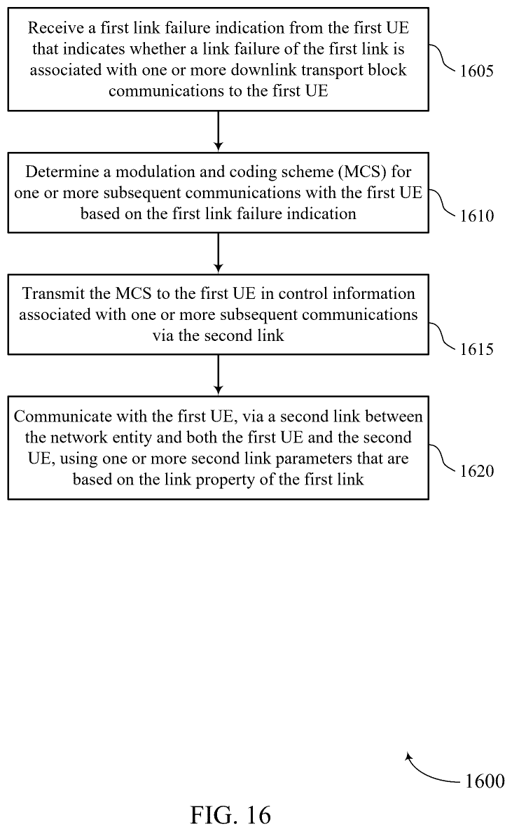

FIG. 16 shows a flowchart illustrating a method 1600 that supports techniques for user equipment cooperation in wireless communications in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include receiving a first link failure indication from the first UE that indicates whether a link failure of the first link is associated with one or more downlink transport block communications to the first UE. The operations of 1605 may be performed in accordance with examples as disclosed herein. In some examples, aspects of the operations of 1605 may be performed by a link quality indication manager 1135 as described with reference to FIG. 11.

At 1610, the method may include determining a MCS for one or more subsequent communications with the first UE based on the first link failure indication. The operations of 1610 may be performed in accordance with examples as disclosed herein. In some examples, aspects of the operations of 1610 may be performed by an MCS manager 1150 as described with reference to FIG. 11.

At 1615, the method may include transmitting the MCS to the first UE in control information associated with one or more subsequent communications via the second link. The operations of 1615 may be performed in accordance with examples as disclosed herein. In some examples, aspects of the operations of 1615 may be performed by an MCS manager 1150 as described with reference to FIG. 11.

At 1620, the method may include communicating with the first UE, via a second link between the network entity and both the first UE and the second UE, using one or more second link parameters that are based on the link property of the first link. The operations of 1620 may be performed in accordance with examples as disclosed herein. In some examples, aspects of the operations of 1620 may be performed by a cooperative communications manager 1130 as described with reference to FIG. 11.

The following provides an overview of aspects of the present disclosure:

Aspect 1: A method for wireless communications at a first UE, comprising: determining a link property of a first link between the first UE and a second UE, wherein the second UE assists with communications between the first UE and a network entity; transmitting an indication of the link property of the first link to the network entity via a second link between the first UE and the network entity; and communicating with the network entity, via the second link using one or more second link parameters that are based at least in part on the link property of the first link.

Aspect 2: The method of aspect 1, wherein transmitting the indication of the link property of the first link comprises: transmitting a first link failure indication to the network entity that indicates whether a link failure of the first link is associated with one or more downlink transport block communications from the network entity.

Aspect 3: The method of aspect 2, wherein the first link failure indication is provided in a multi-state acknowledgment/negative-acknowledgment (ACK/NACK) feedback indication associated with each of the one or more downlink transport block communications that indicates whether the first link experienced a failure associated with a corresponding downlink transport block communication.

Aspect 4: The method of any of aspects 1 through 3, wherein transmitting the indication of the link property of the first link comprises: transmitting a first link quality indication to the network entity that indicates one or more link quality parameters of the first link.

Aspect 5: The method of aspect 4, wherein the one or more link quality parameters of the first link comprise one or more of a first link failure rate, a link failure rate variance, a link failure rate range, correlation in time of first link failures, a predicted failure probability of the first link, a latency of the first link, a signal strength of the first link, measured interference levels of the first link, or a channel contention success rate for the first link.

Aspect 6: The method of any of aspects 4 through 5, wherein the one or more link quality parameters are transmitted to the network entity via one or more of a medium access control (MAC) control element (CE), RRC signaling, uplink control information (UCI), or any combination thereof, and wherein one or more updates to the one or more link quality parameters are transmitted based on a change in an associated value.

Aspect 7: The method of any of aspects 1 through 6, wherein transmitting the indication of the link property of the first link comprises: transmitting a supportable data rate of the first link to the network entity.

Aspect 8: The method of any of aspects 1 through 7, wherein transmitting the indication of the link property of the first link comprises: transmitting an indication of a limit for a data rate associated with the second link based at least in part on a supportable data rate of the first link.

Aspect 9: The method of any of aspects 1 through 8, wherein transmitting the indication of the link property of the first link comprises: transmitting a first buffer status report (BSR) associated with the second UE that is separate from a second BSR associated with the first UE.

Aspect 10: The method of any of aspects 1 through 9, further comprising: modifying a target block error rate of a radio link management procedure based at least in part on an estimated failure rate of the first link, wherein the target block error rate is used for identifying a radio link failure associated with the second link.

Aspect 11: A method for wireless communications at a network entity, comprising: receiving, from a first UE, an indication of a link property of a first link between the first UE and a second UE, wherein the second UE assists with communications between the first UE and the network entity; and communicating with the first UE, via a second link between the network entity and both the first UE and the second UE, using one or more second link parameters that are based at least in part on the link property of the first link.

Aspect 12: The method of aspect 11, wherein receiving the indication of the link property of the first link comprises: receiving a first link failure indication from the first UE that indicates whether a link failure of the first link is associated with one or more downlink transport block communications to the first UE.

Aspect 13: The method of aspect 12, wherein the first link failure indication is provided in a multi-state acknowledgment/negative-acknowledgment (ACK/NACK) feedback indication associated with each of the one or more downlink transport block communications that indicates whether the first link experienced a failure associated with a corresponding downlink transport block communication.

Aspect 14: The method of any of aspects 12 through 13, further comprising: determining a modulation and coding scheme (MCS) for one or more subsequent communications with the first UE based at least in part on the first link failure indication; and transmitting the MCS to the first UE in control information associated with one or more subsequent communications via the second link.

Aspect 15: The method of any of aspects 11 through 14, wherein receiving the indication of the link property of the first link comprises: receiving a first link quality indication from the first UE that indicates one or more link quality parameters of the first link.

Aspect 16: The method of aspect 15, wherein the one or more link quality parameters of the first link comprise one or more of a first link failure rate, a link failure rate variance, a link failure rate range, correlation in time of first link failures, a predicted failure probability of the first link, a latency of the first link, a signal strength of the first link, measured interference levels of the first link, or a channel contention success rate for the first link.

Aspect 17: The method of any of aspects 15 through 16, further comprising: determining a modulation and coding scheme (MCS) for one or more subsequent communications with the first UE based at least in part on the first link quality indication; and transmitting the MCS to the first UE in control information associated with one or more subsequent communications via the second link.

Aspect 18: The method of any of aspects 11 through 17, wherein receiving the indication of the link property of the first link comprises: receiving an indication of a supportable data rate of the first link to the network entity.

Aspect 19: The method of any of aspects 11 through 18, wherein receiving the indication of the link property of the first link comprises: receiving an indication of a limit for a data rate associated with the second link that is based at least in part on a supportable data rate of the first link.

Aspect 20: The method of any of aspects 11 through 19, wherein receiving the indication of the link property of the first link comprises: receiving a first buffer status report (BSR) associated with the second UE that is separate from a second BSR associated with the first UE.

Aspect 21: A first UE for wireless communications, comprising one or more memories storing processor-executable code, and one or more processors coupled with the one or more memories and individually or collectively operable to execute the code to cause the first UE to perform a method of any of aspects 1 through 10.

Aspect 22: A first UE for wireless communications, comprising at least one means for performing a method of any of aspects 1 through 10.

Aspect 23: A non-transitory computer-readable medium storing code for wireless communications, the code comprising instructions executable by one or more processors to perform a method of any of aspects 1 through 10.

Aspect 24: A network entity for wireless communications, comprising one or more memories storing processor-executable code, and one or more processors coupled with the one or more memories and individually or collectively operable to execute the code to cause the network entity to perform a method of any of aspects 11 through 20.

Aspect 25: A network entity for wireless communications, comprising at least one means for performing a method of any of aspects 11 through 20.

Aspect 26: A non-transitory computer-readable medium storing code for wireless communications, the code comprising instructions executable by one or more processors to perform a method of any of aspects 11 through 20.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first user equipment (UE), comprising:
one or more memories storing processor-executable code; and
one or more processors coupled with the one or more memories and individually or collectively operable to execute the code to cause the first UE to:
determine a link property of a first link between the first UE and a second UE, wherein the second UE assists with communications between the first UE and a network entity;
transmit an indication of the link property of the first link to the network entity via a second link between the first UE and the network entity; and
communicate with the network entity, via the second link using one or more second link parameters that are based at least in part on the link property of the first link.

2. The first UE of claim 1, wherein, to transmit the indication of the link property of the first link, the one or more processors are individually or collectively operable to execute the code to cause the first UE to:
transmit a first link failure indication to the network entity that indicates whether a link failure of the first link is associated with one or more downlink transport block communications from the network entity.

3. The first UE of claim 2, wherein the first link failure indication is provided in a multi-state acknowledgment/negative-acknowledgment (ACK/NACK) feedback indication associated with each of the one or more downlink transport block communications that indicates whether the first link experienced a failure associated with a corresponding downlink transport block communication.

4. The first UE of claim 1, wherein, to transmit the indication of the link property of the first link, the one or more processors are individually or collectively operable to execute the code to cause the first UE to:
transmit a first link quality indication to the network entity that indicates one or more link quality parameters of the first link.

5. The first UE of claim 4, wherein the one or more link quality parameters of the first link comprise one or more of a first link failure rate, a link failure rate variance, a link failure rate range, correlation in time of first link failures, a predicted failure probability of the first link, a latency of the first link, a signal strength of the first link, measured interference levels of the first link, or a channel contention success rate for the first link.

6. The first UE of claim 4, wherein the one or more link quality parameters are transmitted to the network entity via one or more of a medium access control (MAC) control element (CE), radio resource control (RRC) signaling, uplink control information (UCI), or any combination thereof, and wherein one or more updates to the one or more link quality parameters are transmitted based on a change in an associated value.

7. The first UE of claim 1, wherein, to transmit the indication of the link property of the first link, the one or more processors are individually or collectively operable to execute the code to cause the first UE to:
transmit a supportable data rate of the first link to the network entity.

8. The first UE of claim 1, wherein, to transmit the indication of the link property of the first link, the one or more processors are individually or collectively operable to execute the code to cause the first UE to:
transmit an indication of a limit for a data rate associated with the second link based at least in part on a supportable data rate of the first link.

9. The first UE of claim 1, wherein, to transmit the indication of the link property of the first link, the one or more processors are individually or collectively operable to execute the code to cause the first UE to:
transmit a first buffer status report (BSR) associated with the second UE that is separate from a second BSR associated with the first UE.

10. The first UE of claim 1, wherein the one or more processors are individually or collectively further operable to execute the code to cause the first UE to:
modify a target block error rate of a radio link management procedure based at least in part on an estimated failure rate of the first link, wherein the target block error rate is used for identifying a radio link failure associated with the second link.

11. A network entity, comprising:
one or more memories storing processor-executable code; and
one or more processors coupled with the one or more memories and individually or collectively operable to execute the code to cause the network entity to:
receive, from a first user equipment (UE), an indication of a link property of a first link between the first UE and a second UE, wherein the second UE assists with communications between the first UE and the network entity; and
communicate with the first UE, via a second link between the network entity and both the first UE and the second UE, using one or more second link parameters that are based at least in part on the link property of the first link.

12. The network entity of claim 11, wherein, to receive the indication of the link property of the first link, the one or more processors are individually or collectively operable to execute the code to cause the network entity to:
receive a first link failure indication from the first UE that indicates whether a link failure of the first link is associated with one or more downlink transport block communications to the first UE.

13. The network entity of claim 12, wherein the first link failure indication is provided in a multi-state acknowledgment/negative-acknowledgment (ACK/NACK) feedback indication associated with each of the one or more downlink transport block communications that indicates whether the first link experienced a failure associated with a corresponding downlink transport block communication.

14. The network entity of claim 12, wherein the one or more processors are individually or collectively further operable to execute the code to cause the network entity to:
determine a modulation and coding scheme (MCS) for one or more subsequent communications with the first UE based at least in part on the first link failure indication; and
transmit the MCS to the first UE in control information associated with one or more subsequent communications via the second link.

15. The network entity of claim 11, wherein, to receive the indication of the link property of the first link, the one or more processors are individually or collectively operable to execute the code to cause the network entity to:
receive a first link quality indication from the first UE that indicates one or more link quality parameters of the first link.

16. The network entity of claim 15, wherein the one or more link quality parameters of the first link comprise one or more of a first link failure rate, a link failure rate variance, a link failure rate range, correlation in time of first link failures, a predicted failure probability of the first link, a latency of the first link, a signal strength of the first link, measured interference levels of the first link, or a channel contention success rate for the first link.

17. The network entity of claim 15, wherein the one or more processors are individually or collectively further operable to execute the code to cause the network entity to:
determine a modulation and coding scheme (MCS) for one or more subsequent communications with the first UE based at least in part on the first link quality indication; and
transmit the MCS to the first UE in control information associated with one or more subsequent communications via the second link.

18. The network entity of claim 11, wherein, to receive the indication of the link property of the first link, the one or more processors are individually or collectively operable to execute the code to cause the network entity to:
receive an indication of a supportable data rate of the first link to the network entity.

19. The network entity of claim 11, wherein, to receive the indication of the link property of the first link, the one or more processors are individually or collectively operable to execute the code to cause the network entity to:
receive an indication of a limit for a data rate associated with the second link that is based at least in part on a supportable data rate of the first link.

20. The network entity of claim 11, wherein, to receive the indication of the link property of the first link, the one or more processors are individually or collectively operable to execute the code to cause the network entity to:
receive a first buffer status report (BSR) associated with the second UE that is separate from a second BSR associated with the first UE.

21. A method for wireless communications at a first user equipment (UE), comprising:
determining a link property of a first link between the first UE and a second UE, wherein the second UE assists with communications between the first UE and a network entity;
transmitting an indication of the link property of the first link to the network entity via a second link between the first UE and the network entity; and
communicating with the network entity, via the second link using one or more second link parameters that are based at least in part on the link property of the first link.

22. The method of claim 21, wherein transmitting the indication of the link property of the first link comprises:
transmitting a first link failure indication to the network entity that indicates whether a link failure of the first link is associated with one or more downlink transport block communications from the network entity.

23. The method of claim 22, wherein the first link failure indication is provided in a multi-state acknowledgment/negative-acknowledgment (ACK/NACK) feedback indication associated with each of the one or more downlink transport block communications that indicates whether the first link experienced a failure associated with a corresponding downlink transport block communication.

24. The method of claim 21, wherein transmitting the indication of the link property of the first link comprises:
transmitting a first link quality indication to the network entity that indicates one or more link quality parameters of the first link.

25. The method of claim 21, further comprising:
modifying a target block error rate of a radio link management procedure based at least in part on an estimated failure rate of the first link, wherein the target block error rate is used for identifying a radio link failure associated with the second link.

26. A method for wireless communications at a network entity, comprising:
receiving, from a first user equipment (UE), an indication of a link property of a first link between the first UE and a second UE, wherein the second UE assists with communications between the first UE and the network entity; and
communicating with the first UE, via a second link between the network entity and both the first UE and the second UE, using one or more second link parameters that are based at least in part on the link property of the first link.

27. The method of claim 26, wherein receiving the indication of the link property of the first link comprises:
receiving a first link failure indication from the first UE that indicates whether a link failure of the first link is associated with one or more downlink transport block communications to the first UE.

28. The method of claim 27, further comprising:
determining a modulation and coding scheme (MCS) for one or more subsequent communications with the first UE based at least in part on the first link failure indication; and
transmitting the MCS to the first UE in control information associated with one or more subsequent communications via the second link.

29. The method of claim 26, wherein receiving the indication of the link property of the first link comprises:
receiving a first link quality indication from the first UE that indicates one or more link quality parameters of the first link.

30. The method of claim 29, further comprising:
determining a modulation and coding scheme (MCS) for one or more subsequent communications with the first UE based at least in part on the first link quality indication; and
transmitting the MCS to the first UE in control information associated with one or more subsequent communications via the second link.
